(19) United States
(12) Patent Application Publication
(10) Pub. No.: US 2026/0250141 A1
(43) Pub. Date: Aug. 27, 2026

(54) PROCESSES FOR PRODUCING BERYLLIUM CARBIDE POWDER

(71) Applicant: MATERION CORPORATION, Mayfield Heights, OH (US)

(72) Inventors: Sekyung CHANG, Mayfield Heights, OH (US); James L. SIPE, Jr., Mayfield Heights, OH (US); Robert E. KUSNER, Mayfield Heights, OH (US); Keith J. SMITH, Mayfield Heights, OH (US)

(73) Assignee: MATERION CORPORATION, Mayfield Heights, OH (US)

(21) Appl. No.: 19/163,485

(22) PCT Filed: Mar. 8, 2024
(86) PCT No.: PCT/US2024/019032

§ 371 Date: Sep. 9, 2025

Related U.S. Application Data
(60) Provisional application No. 63/489,526, filed on Mar. 10, 2023.

(51) Int. Cl. C01B 32/914

(52) U.S. Cl. CPC C01B 32/914; C01P 2002/72

(57) ABSTRACT

A process for producing beryllium carbide powder comprising calcining a blend composition comprising a beryllium-containing compound and a carbon powder at a first calcination temperature to yield a composite powder, milling the composite powder to form a milled powder, stirring the milled powder in a heavy liquid to form a suspension, and separating at least a portion from the suspension to yield the beryllium carbide powder. In one embodiment, a sacrificial layer may be used during the calcination. The process produces a high purity beryllium carbide powder.

### CROSS-REFERENCE TO RELATED APPLICATION

This application claims priority to U.S. Provisional Application No. 63/489,526, filed Mar. 10, 2023, which is fully incorporated by reference herein.

### GOVERNMENT INTEREST STATEMENT

This invention was made with government support under grant no. HQ0034-19-9-0013 awarded by Department of Defense. The government has certain rights in the invention.

### TECHNICAL FIELD

The present disclosure relates to processes for producing a beryllium carbide powder. In particular to processes for producing high purity beryllium carbide powder with low impurities.

### BACKGROUND

Beryllium carbide (Be₂C) possesses a high scattering and a low absorption cross section to neutron that is suitable as a neutron moderator. Be₂C is a potential first-wall material for fusion reactors, one on the very limited list of possible candidates. Unfortunately one limitation is a lack of high-quality reactor moderator materials due to impurities. Impurities can include beryllium nitride, beryllium oxide, free carbon, and metallic impurities. The reactor moderators are prepared from beryllium carbide powder that are in turned prepared using a hot pressing technique of beryllium powder and carbon powder, i.e. graphite.

Beryllium carbide, Be₂C, may be prepared by calcining a mixture of beryllium oxide and carbon to 1950° C. to 2000° C. in a confined environment such as a graphite die in hot pressing and a sealed canister in hot isostatic pressing. The reaction is accompanied by a substantial exotherm. As a result of the high temperatures, impurities such as beryllium nitride are difficult to control and Be₂C is susceptible to dissociation. The hot pressing techniques also tended to result in agglomerates during densification. These agglomerates require intensive processing to convert to powders that can be sintered.

The need exists for an uncomplicated, solid state powder synthesis process that provides improvements in yield to beryllium carbide powder and more specifically for producing high purity beryllium carbide powder.

### SUMMARY

The present disclosure describes a process for producing beryllium carbide powder comprising calcining a composition comprising a beryllium-containing compound and a carbon powder at a first calcination temperature to yield a composite powder, milling the composite powder to form a milled powder, stirring the milled powder in a heavy liquid to form a suspension, and separating at least a portion from the suspension to yield the beryllium carbide powder.

In one aspect there is provided a process with at least two calcination steps for producing beryllium carbide powder. This process may comprise calcining a composition comprising calcining a beryllium-containing compound and a carbon powder at a first calcination temperature to yield a composite powder, milling the composite powder to form a milled powder, calcining the milled powder at a second calcination temperature greater than the first calcination temperature, following a second milling step, and stirring the milled powder in a heavy liquid to form a suspension. The conversion to Be₂C at the first calcination temperature may be from 10 to 92%, more preferably from 85% to 92%, while the conversion at the second calcination temperature may be from 90% to 99%. The process further comprises separating at least a portion from the suspension to yield the beryllium carbide powder. A sacrificial layer may be used during either or both of the calcination steps. In a preferred embodiment, the sacrificial layer may be used for the second calcination step.

In one aspect there is provided process for producing beryllium carbide powder comprising calcining a composite powder comprising beryllium carbide at a calcination temperature of less than 1200° C., wherein the composite powder is in a crucible that is at least partially surrounded by a sacrificial layer, stirring the milled powder in a heavy liquid to form a suspension, and separating at least a portion from the suspension to yield the beryllium carbide powder. In one embodiment, the sacrificial powder comprises beryllium carbide powder.

These and other non-limiting characteristics are more particularly described below.

### BRIEF DESCRIPTION OF DRAWINGS

The present disclosure is described in detail below with reference to the appended drawings, wherein like numerals designate similar parts.

FIG. 1 is a SEM image of a beryllium powder for blending into the composite powder in accordance with an embodiment of the present invention.

FIG. 2 is a SEM image of a carbon powder for blending into the composite powder in accordance with an embodiment of the present invention.

FIG. 3 is a schematic of two crucibles containing the composite powder surrounded by a sacrificial layer in accordance with an embodiment of the present invention.

FIG. 4 is an XRD profile of the Be₂C powder of an exemplary embodiment.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

In general, the beryllium carbide (Be₂C) powder is produced by the calcination of a blended beryllium-containing compound, preferred a beryllium powder, and carbon powder followed by segregation of non-Be₂C powders. The starting powder, e.g., beryllium powder and carbon powder, may be blended and calcined prior to segregation. In one embodiment, the non-Be₂C powders are segregated by using a heavy liquid. As described further herein the process produces the Be₂C powder by milling. This process is efficient in producing Be₂C powder and more preferably efficient in producing high purity Be₂C powder.

### In One Embodiment, the Process May Employ One or More of the Following Steps:

a) blending precursors to Be₂C;
b) calcining the blended precursors to form a composite powder;
c) milling the composite powder;
d) stirring the milled powder with heavy liquid; and
e) separating the Be₂C powder.

In some embodiments, there may be two or more calcination steps. After each calcination step there may be a milling step. Accordingly, in one embodiment, the process may employ one or more of the following steps:
a) blending precursors to Be₂C;
b) calcining (first calcination) the blended precursors to form a composite powder;
c) milling (first milling) the composite powder;
d) calcining (second calcination) the milled powder;
e) milling (second milling) the milled powder;
f) stirring the milled powder with heavy liquid; and
g) separating the Be₂C powder.

As used herein the term “high purity” characterizes a precursor or a Be₂C powder that contains less than or equal to 0.1% by weight of impurities and more preferably less than 100 ppm by weight. The process is preferably suited for produce high purity Be₂C powder having a low beryllium oxide as well as beryllium nitride impurities. High contents of beryllium oxide are reduced by forming the Be₂C powder in an inert environment. In some embodiments, the process may also reduce free carbon impurities in the Be₂C powder. In some embodiments, the process may further reduce metallic impurities, such as but not limited to iron, copper, nickel, magnesium, aluminum, silicon, cobalt, or combinations thereof. Accordingly, a preferred Be₂C powder possesses high purity of greater than or equal to 99.9% by weight of Be₂C, and preferably greater than or equal to 99.95% by weight, or more preferably greater than or equal to 99.99% by weight.

In one embodiment, the process may blend precursors including a beryllium-containing compound and a carbon powder. The molar ratio of beryllium in the beryllium-containing compound to the carbon powder may be from 3:1 to 1.1:1, e.g., from 3:1 to 1.5:1, or from 2.5:1 to 1:5:1, or about a stoichiometric ratio, i.e. 2:1. In one embodiment, a stoichiometric composition of beryllium-containing compound and carbon powder may be blended in a blender or mixer.

The processes described herein use a beryllium precursor, which preferably may comprise a beryllium-containing compound. The beryllium-containing compound may include beryllium, beryllium hydride, beryllium chloride, beryllium fluoride, or combinations thereof. Beryllium oxide is not a preferred beryllium-containing compound, and in one embodiment, the beryllium-containing compound contains no beryllium oxide. In one embodiment, the beryllium-containing compound may contain more than 10% by weight of beryllium, e.g., more than 15% by weight, more than 20% by weight, more than 25% by weight, more than 50% by weight, or more than 95% by weight. In one embodiment, the beryllium-containing compound may contain more than 99% by weight of beryllium, e.g., more than 99.9% by weight of beryllium, more than 99.95% by weight or more than 99.99% by weight. Although trace elements are significantly reduced, the beryllium-containing compound may have trace elements (e.g., less than 0.05% by weight and more preferably less than 0.01% by weight) of Fe, Al, Mg, and Si.

The beryllium-containing compound may comprise a beryllium powder. The beryllium powder may have an average mean particle size of less than or equal to 50 microns, e.g., less than or equal to 45 microns, less than or equal to 40 microns, less than or equal to 35 microns, less than or equal to 30 microns, less than or equal to 25 microns, or less than or equal to 20 microns. In terms of ranges, the beryllium powder may have an average mean particle size from 1 to 50 microns, e.g., from 5 to 50 microns, from 5 to 40 microns, from 10 to 40 microns, from 10 to 30 microns, or from 15 to 25 microns.

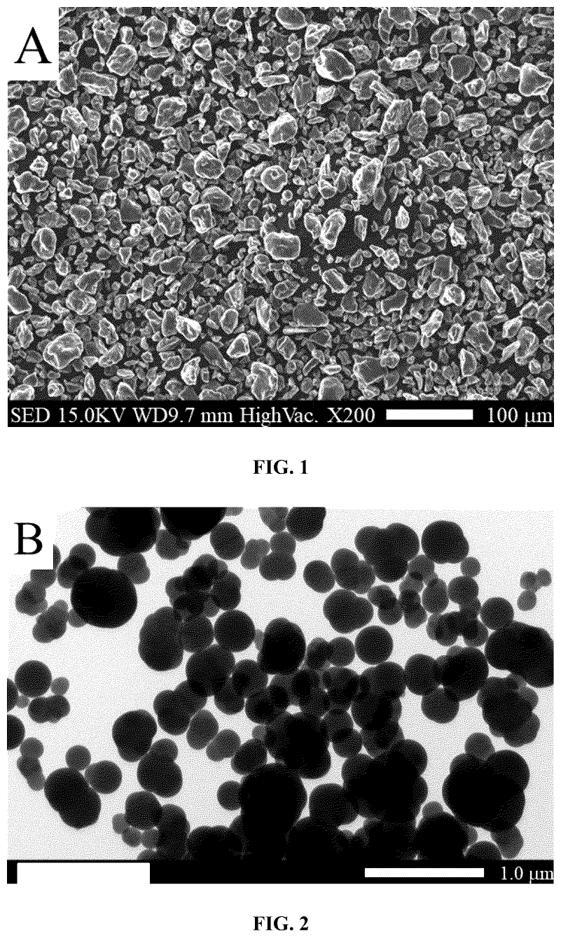

In one embodiment, the beryllium powder may be produced through impact grinding. FIG. 1 is an SEM image of beryllium powder showing no particle agglomeration and no flakes present in the powder. Minimizing or eliminating agglomeration is important to ensure intimate mixing of the beryllium powder with the carbon precursor during calcining.

In one embodiment, a spherical beryllium powder may be used. The spherical beryllium powder may be produced preferably through an atomization process from liquid beryllium. Suitable atomization processes include spray drying, which is initiated with a feed solution (including the beryllium-containing compound) being atomized into small droplets due to decreased surface tension. Spray drying may include contacting the spray with heated air.

In addition to the beryllium precursor, the process uses a carbon precursor. In one embodiment, the carbon precursor is a carbon powder. The carbon powder may be graphite or activated charcoal. In some embodiments, the source of the carbon powder may be fossil fuels, biomass, or combinations thereof. The carbon powder may have a high purity to prevent intrusion of impurities into the Be₂C powder. In one embodiment, carbon powder may be produced by milling, pulverizing, or through an atomization process (such as described above).

The carbon powder may have an average mean particle size of less than or equal to 500 microns, e.g., less than or equal to 450 microns, less than or equal to 400 microns, less than or equal to 350 microns, less than or equal to 300 microns, less than or equal to 250 microns, or less than or equal to 200 microns. In terms of ranges, the carbon powder may have an average mean particle size from 1 to 500 microns, e.g., from 50 to 500 microns, from 50 to 450 microns, from 100 to 400 microns, from 150 to 350 microns, or from 150 to 250 microns.

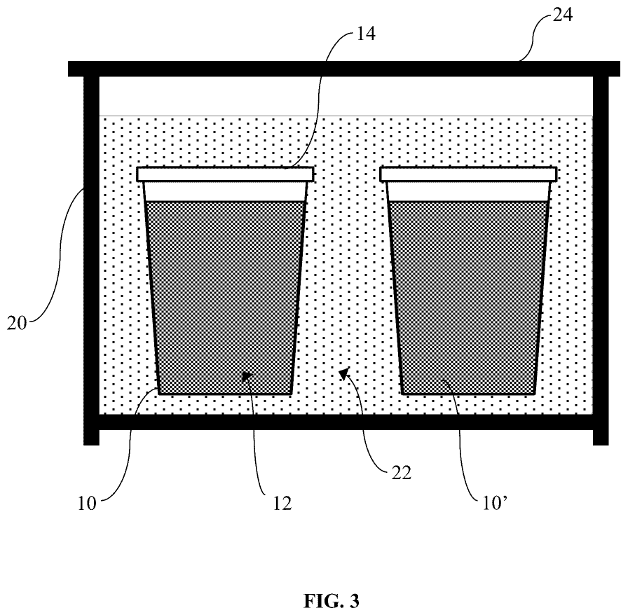

FIG. 2 is an SEM image of carbon powder having spherical particles. While spherical particles are preferred owing to a narrow size distribution that demonstrates good flowability and uniformity, shapes other than spherical, e.g., flakes or nanoflakes may be used.

In one embodiment, the beryllium powder and carbon powder are preferably dry, inclusion-free and without agglomerates. The powders may be blended for a period from 0.1 to 72 hours, e.g., from 0.1 to 48 hours, from 0.1 to 36 hours, from 0.1 to 18 hours, from 0.1 to 12 hours, from 0.1 to 6 hours, from 0.2 to 5 hours, from 0.25 to 4 hours, from 0.5 to 4 hours, from 0.5 to 3.5 hours, from 0.5 to 3 hours, or from 0.5 to 2 hours. The period of blending should be sufficient to form a composite powder, and preferably a homogenous composite powder. Suitable types of blenders include acoustic mixers, vibratory mixers, shear mixers, ribbon blenders, drum blenders, diffusion mixers, and bin blenders. In one embodiment, an acoustic mixer may be used to enable thorough and efficient mixing of the powder.

During blending, the temperature may be less 100° C., e.g., less than 75° C., less than 50° C., less than 25° C., less than 22° C. Preferably the blending may be done at room temperature under atmospheric pressure.

In one embodiment, the beryllium powder and carbon powder may be loosely packed to minimize the formation of hard agglomerates. The loosely packed starting powder improves the process along with the low calcination temperatures described herein.

After the powders are blended, in one embodiment, the blended powder may be examined to determine the presence of any agglomerations. Agglomerated powder may be removed by screening. In some embodiments, the blending may be performed in a liquid medium to reduce and/or remove agglomeration. When liquid is used, the process may dry, preferably thoroughly dry, the composite powder before the process continues.

In another embodiment, the blended powder blend may be compacted to form green compacts for calcining. The green compacts improve the process to enhance the transformation to the Be₂C phase, which advantageously may be performed at lower calcining temperatures, at shorter times, and/or with fewer calcination cycles-all of which contribute to a more efficient process, e.g., a process with improved yield and higher phase purity.

In one embodiment, the process may use a blended composite of beryllium and carbon without having to blend the powders. Accordingly, in one embodiment, the process may comprise:
a) calcination of a blended composite powder comprising Be and C;
b) milling the composite powder;
c) stirring the milled powder with heavy liquid; and
d) separation of the Be₂C powder.

To initiate the reaction of the precursors in the composite powder, the process preferably uses one or more calcination steps. Each of the calcination steps may be performed at a relatively low temperature to minimize the occurrence of hard agglomerates. Prior to the improvements made by the present inventors, the prior processes used high calcination temperature and hot pressing techniques that resulted in Be₂C powder with a high percentage of hard agglomerates. These prior techniques did not recognize the detrimental influence of hard agglomerates during calcining. This increase of hard agglomerates necessities extensive milling, during which the agglomerates are difficult to remove and increase the impurity content.

Be₂C tends to dissociate at about 2150° C. Even at temperature around 1000° C. Be₂C has been shown to dissociate at slower rates. The dissociation at lower temperature may be through evaporation. To avoid (or minimize) the dissociation of Be₂C, prior processes performed the calcination in a confined environment, such as a graphite die in hot pressing and a sealed canister in hot isostatic pressing. This led to an unnecessary increase in costs, reduced the quality of the Be₂C powder, and reduced production rates. In one embodiment, by controlling the temperature to be relatively low the process may reduce beryllium nitride and beryllium oxide to produce high purity Be₂C powder.

To produce Be₂C powder according to the embodiments described herein the calcination temperature may be relatively lower. In one embodiment, the calcination temperature preferably may be controlled to be less than or equal to 1200° C., e.g., less than or equal to 1175° C., less than or equal to 1150° C., less than or equal to 1125° C., less than or equal to 1100° C., less than or equal to 1075° C., less than or equal to 1050° C., less than or equal to 1025° C., less than or equal to 1000° C., less than or equal to 975° C., less than or equal to 950° C., or less than or equal to 925° C. In one embodiment, the minimum temperature for the calcining may be at least equal to or greater than 850° C., e.g., at least equal to or greater than 875° C., at least equal to or greater than 900° C., at least equal to or greater than 925° C., at least equal to or greater than 950° C., at least equal to or greater than 975° C., or at least equal to or greater than 1000° C. Conversion rates tend to be suppressed when the calcination temperature is too low. In terms of ranges the calcination temperature may be from 850° C. to 1200° C., e.g., from 875° C. to 1175° C., from 900° C. to 1150° C., from 910° C. to 1125° C., from 925° C. to 1100° C., from 925° C. to 1075° C., from 925° C. to 1050° C., or from 950° C. to 1050° C.

Calcining may be carried out by heating the composite powder at a heating rate of greater than or equal to 1° C./min, e.g., greater than 1.5° C./min, greater than 2° C./min, greater than 2.5° C./min, greater than 3° C./min, greater than 3.5° C./min, greater than 4° C./min, greater than 4.5° C./min, or greater than 5° C./min. Calcining may be carried out for 0.1 to 24 hours, e.g., from 0.2 to 12 hours, from 0.5 to 6 hours, or from 0.5 to 4 hours. After reaching the calcination temperature, the process uses an isotherm at the calcination temperature for up to 12 hours, e.g., up to 11 hours, up to 10 hours, up to 9 hours, up to 8 hours, up to 7 hours, up to 6 hours, up to 5 hours, up to 4 hours, up to 3 hours, up to 2 hours, up to 1.5 hours or up to 1 hour. The calcination may be done under an inert atmosphere, e.g., nitrogen or argon, or under vacuum. The heating rate and duration is controlled to prevent excess impurity formation.

In one embodiment, that the composite powder is put into crucible made of carbon, such as graphite, silicon or a refractory metal, such as niobium, tantalum, molybdenum, tungsten, or alloys thereof. The crucible may be provided with a lid to seal to the crucible thereby forming an suitable reducing atmosphere for the composite powder.

In one embodiment, the calcination step has a conversion of the precursors (or the blended composite powder) to beryllium carbide that is greater than 10%, e.g., greater than 20%, greater than 40%, greater than 50%, greater than 60%, greater than 70%, greater than 80%, greater than 85%, greater than 87%, greater than 90% or greater than 92%. High conversions are preferred to reduce the formation of impurities.

As indicated the process may involve one or more calcination steps. Preferably following each calcination step there is a separate milling step. Additional calcining/milling steps may be used to increase the conversion to beryllium carbide. In one embodiment, the calcination temperature of each successive calcination step may be slightly increased.

The calcination temperature of the first calcination step is done under conditions to control the exothermic reaction and prevent excess heat generation that can lead to impurities, such as beryllium nitride. In one embodiment, the process includes a first (initial) calcination step may be carried out by heating the composite powder to a first (initial) calcination temperature of at least equal to or greater than 850° C., e.g., at least equal to or greater than 870° C., at least equal to or greater than 875° C., at least equal to or greater than 890° C., at least equal to or greater than 900° C., at least equal to or greater than 905° C., at least equal to or greater than 910° C., at least equal to or greater than 915° C., or at least equal to or greater than 925° C. The first calcination temperature preferably may be less than or equal to 950° C., e.g., less than or equal to 920° C., less than or equal to 915° C., less than or equal to 910° C., less than or equal to 905° C., less than or equal to 900° C. In terms of ranges the first calcination temperature may be from 850° C. to 950° C., e.g., from 875° C. to 930° C., from 890° C. to 925° C., from 900° C. to 925° C., or from 905° C. to 920° C. The conversion after the first calcination may be from 10% to 92%, e.g., from 40% to 92%, from 60% to 92%, from 75% to 92%, or from 85% to 92%.

The first calcination may be carried out by heating the composite powder at a heating rate of greater than 1° C./min, e.g., greater than 1.5° C./min, greater than 2° C./min, greater than 2.5° C./min, greater than 3° C./min, greater than 3.5° C./min, greater than 4° C./min, greater than 4.5° C./min, or greater than 5° C./min. The first calcination may be carried out from 0.1 to 24 hours, e.g., from 0.2 to 12 hours, from 0.5 to 6 hours, or from 0.5 to 4 hours. After reaching the first calcination temperature, the process uses an isotherm at the first calcination temperature for up to 4 hours, e.g., up to 3 hours, up to 2 hours, up to 1.5 hours, or up to 1 hour. The first calcination may be done under an inert atmosphere, e.g., nitrogen or argon, or under vacuum. Preferably the calcination may be done under an inert atmosphere comprising argon to limit formation of beryllium nitride.

To achieve higher conversions to beryllium carbide, a further calcination step or steps (second calcination) may be used having calcination (second) temperature is greater than the first calcination temperature. In one embodiment, the second or subsequent calcination may be carried out by heating the composite powder to a second calcination temperature of at least equal to or greater than 1000° C., e.g., at least equal to or greater than 1020° C., at least equal to or greater than 1035° C., at least equal to or greater than 1040° C., at least equal to or greater than 1050° C., at least equal to or greater than 1060° C., at least equal to or greater than 1065° C., or at least equal to or greater than 1075° C. The second calcination temperature preferably may be less than or equal to 1200° C., e.g., less than or equal to 1190° C., less than or equal to 1175° C., less than or equal to 1150° C., less than or equal to 1125° C., less than or equal to 1100° C., less than or equal to 1095° C., less than or equal to 1090° C., less than or equal to 1085° C., less than or equal to 1080° C., less than or equal to 1075° C. In terms of ranges the second calcination temperature may be from 1000° C. to 1200° C., e.g., from 1000° C. to 1175° C., from 1005° C. to 1150° C., from 1005° C. to 1125° C., from 1005° C. to 1100° C., from 1005° C. to 1095° C., from 1025° C. to 1075° C., from 1030° C. to 1060° C., or from 1045° C. to 1055° C.

The conversion to beryllium carbide after the second calcination step may be greater than 90%, e.g., greater than 92%, greater than 93%, greater than 95% or greater than 96%. In terms of ranges the conversion after the second calcination step may be from 90% to 100%, e.g., from 90% to 99%, from 90% to 98% or from 90% to 96%.

Similarly, the second calcination may be carried out by heating the milled powder at a heating rate of greater than 1° C./min, e.g., greater than 1.5° C./min, greater than 2° C./min, greater than 2.5° C./min, greater than 3° C./min, greater than 3.5° C./min, greater than 4° C./min, greater than 4.5° C./min, or greater than 5° C./min. The second calcination may have a different or similar heating rate. The second calcination may be carried out for 0.1 to 24 hours, e.g., from 0.2 to 12 hours, from 0.5 to 8 hours, or from 0.5 to 6 hours. After reaching the second calcination temperature, the process uses an isotherm at the second calcination temperature for up to 4 hours, e.g., up to 3 hours, up to 2 hours, up to 1.5 hours or up to 1 hour. The second calcination may be done under an inert atmosphere, e.g., nitrogen or argon, or under vacuum. Preferably the calcination may be done under an inert atmosphere comprising argon to limit formation of beryllium nitride.

In one embodiment, the calcination step may use a sacrificial layer. The sacrificial layer may surround at least a portion the composite or milled powder. In one embodiment, the sacrificial layer may surround at least a portion of the crucible containing the powder, and preferably surrounds the crucible. The sacrificial layer reduces, and more preferably prevents, dissociation of the beryllium carbide powder at the higher temperatures in the second calcination step. The sacrificial layer reduces, and more preferably prevents, formation of beryllium oxide within the beryllium carbide powder. The present inventors have found that beryllium oxide forms in the sacrificial layer, gettering oxygen from the inner layer. In one embodiment, the sacrificial layer comprises beryllium, beryllium carbide, carbon, molybdenum and combinations thereof. In one embodiment, the sacrificial layer comprises a combination of beryllium carbide and carbon. In one embodiment, the sacrificial layer comprises a combination of beryllium carbide and molybdenum.

In one embodiment, sacrificial layers may be used for the first calcination step and separately for the second or subsequent calcination step. Although the same sacrificial layer may be used in each calcination, it is preferred that an unused sacrificial layer is used for each calcination step.

FIG. 3 is a schematic illustration of a sacrificial layer 22 surrounding a crucible 10, 10′ containing the composite powder 12. As shown in FIG. 3, there are two crucibles, 10 and 10′, and it should be understood that multiple crucibles may be calcined together in the sacrificial layer 22. In one embodiment, a single crucible may be used. Each of the crucibles 10 and 10′ are loaded with the composite powder 12 and a lid 14 is placed on the crucible 10, 10′. Once loaded the crucibles 10, 10′ are placed in a housing 20 that contains a sacrificial layer 22. As shown in FIG. 3, sacrificial layer 22 surrounds each crucible 10, 10′. A covering 24 may be used to close the housing 20 prior to calcination. As the temperature increases, the sacrificial layer 24 acts a barrier to prevent formation of oxides, in particular beryllium oxide, in the composite powder 12. Once the process is done the crucibles 10, 10′ may be removed from the housing 20. The sacrificial layer 22 may be discharged before the next calcination.

In one embodiment, after blending and calcining, the composite powder may be subjected to a milling process, preferably a high energy milling process. The milling process may be a batch step. The milling process may use planetary ball mill, a tumbler ball mill, a rod milling process, an attritor milling process, a teamer mill, a rotary mill, or other methods to provide high energy mixing. The process described herein prevents unwanted sources of impurities during the milling. The milling process may be used to control the particle size of the powder. In one embodiment, a uniform particle size may be achieved using a milling process. In some embodiments, the milling process yields a powder having an average mean particle size of less than or equal to 5 microns, e.g., less than or equal to 4 microns, less than or equal to 3 microns, less than or equal to 2 microns, less than or equal to 1 micron, less than or equal to 0.5 microns. In terms of ranges for the powder, the average mean particle size may be from 0.1 to 5 microns, e.g., from 0.5 to 5 microns, from 0.5 to 4 microns, from 1 to 4 microns, from 1 to 3 microns, or from 1 to 2 microns.

There are several factors that are interrelated to control during millings. These factors include the amount of the composite powder used during milling, the milling energy, milling speed revolutions per minute (RPM), diameter of the ball milling vessel, composite powder mixture loading, volume of the composite powder, volume and/or weight of grinding media, and wear characteristics of the grinding media.

The milling step using a suitable grinding media in a grinding jar. In one embodiment, the diameter of the grinding jar may range from 10 to 100 cm, more preferably 15 cm to 60 cm, in diameter and from 10 to 100 cm, more preferably from 15 cm to 60 cm, in height. The grinding media may have a high density to avoid contamination of the Be₂C powder. The grinding media must not contaminate the powder and should be easily removed. In addition, the grinding media used for the present invention should have a low propensity to create dust clouds that could lead to ignition in a confined environment. Exemplary grinding media may include but is not limited to silicon carbide, tungsten carbide, alumina, zirconia, or combinations thereof. In preferred embodiments, the grinding media may be silicon carbide, tungsten carbide, or combinations thereof. The tungsten carbide may be mixed with a metallic binder such as cobalt, nickel, or iron, to increase the hardness. The wear of the grinding media should be low, less than 5% by weight, e.g. less than 2.5% by weight, less than 1% by weight, or less than 0.5% by weight.

The grinding media employed in the embodiments disclosed herein may be grinding media having a mean diameter from 1 to 20 mm, e.g., from 1 to 18 mm, from 2 to 16 mm, from 3 to 15 mm, or from 5 to 12 mm. To maintain milling and prevent deterioration of milling, the grinding media preferably has a mean diameter of at least equal to or greater than 1 mm, e.g., at least equal to or greater than 1.5 mm, at least equal to or greater than 2 mm or at least equal to or greater than 3 mm. When the grinding media is too large the composite powder of beryllium is poorly milled, and thus it is preferred that the grinding media has a mean diameter of less than or equal to 20 mm, e.g., less than 18 mm, less than 16 mm, less than 15 mm, less than 12 mm, less than 10 mm, or less than 5 mm. In one embodiment, at least two types of grinding media having distinct mean diameters may be used together as the grinding media. The grinding media has a size that is selected to be sufficiently distinct from the beryllium carbide to allow recovery. In one embodiment, the grinding jar is loaded with grinding media to powder mass ratio from 2:1 to 100:1, e.g., from 3:1 to 50:1, from 3:1 to 25:1, or from 5:1 to 15:1.

In addition, the grinding jar may have a lining to reduce erosion into the Be₂C powder. The grinding jar may be a polymer lined ball milling vessel. In one embodiment, the grinding jar may be lined with carbide sleeves. In some embodiments, the grinding jar may be lined with polyurethane or rubber. To avoid contamination the process may avoid the use of unlined or lined low-carbon steel or stainless steel grinding jars.

The milling step may be conducted for suitable period of time to achieve the powder. In one embodiment, the milling step is greater than 5 minutes, e.g., greater than 10 minutes, greater than 25 minutes, greater than 50 minutes, greater than 120 minutes, or greater than 180 minutes. The milling step may be less than 24 hours, e.g., less than 20 hours, less than 18 hours, less than 15 hours, less than 12 hours, less than 9 hours, less than 6 hours, less than 2 hours, or less than 1 hour. During the milling time, the process is carried out under conditions to prevent oxidation of the precursors or powder. In one embodiment, the milling is conducted under nitrogen, argon, or other inert atmosphere or under vacuum.

The milling step may be wet or dry. Preferably dry milling is used. When wet milling is used the process may include a drying step.

As described herein there may be a milling step following each of the calcining steps. In one embodiment, similar grinding media and/or conditions are used for each milling step. In other embodiments, different types of grinding media and/or may be used.

After the milling step is completed, a heavy liquid is stirred with the milled powder to form a suspension. The mixing with the heavy liquid is done under conditions that prevent dissociation of the beryllium carbide. In one embodiment the heavy liquid segregates the non-Be₂C powder, namely impurities and beryllium oxide.

The heavy liquid may have a density that is greater than the density of Be₂C (2.4 g/cm³). This may allow the Be₂C to become suspended and float in the heavy liquid, while impurities and in particular beryllium oxide, eroded as sediment. In one embodiment, the heavy liquid has a density that is greater than 2.44 g/cm³ at 20° C., e.g. preferably greater than 2.5 g/cm³ at 20° C., greater than 2.6 g/cm³ at 20° C. or greater than 2.7 g/cm³ at 20° C. In one embodiment, the heavy liquid has a density that less than beryllium oxide, which is about 3.0 g/cm³ to 3.1 g/cm³. When the heavy liquid has a density that is greater than about 3.1 g/cm³ the beryllium oxide may not erode. Therefore, suitable ranges for the density of the heavy liquid may be from 2.44 g/cm³ to 3.1 g/cm³, e.g., 2.45 g/cm³ to 3.05 g/cm³, 2.47 g/cm³ to 3.0 g/cm³, or 2.5 g/cm³ to 3.0 g/cm³. In one embodiment, the heavy liquid comprises at least one liquid selected from the group of bromoform, dibromomethane, tetrabromomethane, diiodomethane, or combinations thereof.

In one embodiment, the suspension comprises from 10% by weight to 90% by weight of the heavy liquid, e.g., from 20% by weight to 85% by weight, from 25% by weight to 70% by weight, from 30% by weight to 65% by weight.

The milled powder is mixed with the heavy liquid at a temperature of less than 100° C., e.g., less than 60° C., less than 40° C., less than 30° C., less than 25° C., or more preferably around room temperature.

After mixing to form a suspension, at least a portion is separated from the suspension by filtration and/or centrifuge. This portion is enriched in beryllium carbide and has low beryllium oxide content of less than 1.5% by weight. In one embodiment, the separated portion comprises high purity beryllium carbide having very low impurity levels. The beryllium carbide may have less than 0.5% by weight of beryllium oxide, e.g., less than 0.25% by weight of beryllium oxide, less than 0.1% by weight of beryllium oxide, or less than 0.05% by weight of beryllium oxide.

In one embodiment, the portion may be separated using a filtration process using a series of filters having meshes from 60 to 400. For example, the filtration may use a succession of screens having 120 meshes, 300 meshes and 400 meshes. The filtration may be employ vibration.

In one embodiment, the portion may be separated using a centrifuge. The centrifuge may operate from 500 to 10,000 rpm, e.g., from 1,000 to 5,000 rpm, or from 1,500 to 3,500 rpm for a period of at least 0.5 minutes or more, e.g., at least 1 minute, at least 3 minutes, at least 5 minutes or at least 10 minutes.

In one embodiment, the portion separated is removed from the upper portion of the suspension. The remaining portion of the suspension may be treated and recycled as necessary.

Due to the hygroscopic nature of Be₂C, the recovered portion may be subsequently dried. In one embodiment, a drying oven may be used at a temperature from 200° C. to 750° C., e.g., from 200° C. to 600° C., or from 350° C. to 550° C. The dried time may vary but is at least 5 minutes or more, e.g., at least 10 minutes, at least 15 minutes, at least 20 minutes, at least 25 minutes, or at least 30 minutes. Longer times may be used but it is preferred to increase the temperature of drying to remove any absorbed or retained moisture. Subsequently the Be₂C should be handled in a manner that avoids exposure to moisture.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application, as they relate to polymers or polymer compositions, reflect average values for a composition that may contain individual polymers of different characteristics. The numerical values disclosed herein should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 microns to 5 microns” is inclusive of the endpoints, 2 microns and 5 microns, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof. In some embodiments, any or some of the steps or components disclosed herein may be considered optional. In some cases, any or some of the aforementioned items in this description may be expressly excluded, e.g., via claim language. For example claim language may be modified to recite additional process steps.

Embodiment 1 is a process for producing beryllium carbide powder comprising calcining a composition comprising a beryllium-containing compound and a carbon powder at a first calcination temperature to yield a composite powder; milling the composite powder to form a milled powder; stirring the milled powder in a heavy liquid to form a suspension; and separating at least a portion from the suspension to yield the beryllium carbide powder.

Embodiment 2 is the process of embodiment 1, wherein a molar ratio of beryllium in the beryllium-containing compound to the carbon powder is from 3:1 to 1.1:1.

Embodiment 3 is the process of any one of embodiments 1 or 2, wherein the beryllium-containing compound comprises at least one from the group of beryllium, beryllium hydride, beryllium chloride, beryllium fluoride, or combinations thereof.

Embodiment 4 is the process of any one of embodiments 1-3, wherein the beryllium-containing compound is a beryllium powder.

Embodiment 5 is the process of embodiment 4, wherein the beryllium powder has an average mean particle size of less than or equal to 50 microns.

Embodiment 6 is the process of any one of embodiments 1-5, wherein the carbon powder has an average mean particle size of less than 50 microns.

Embodiment 7 is the process of any one of embodiments 1-6, wherein the first calcination temperature is at least equal to or greater than 850° C.

Embodiment 8 is the process of any one of embodiments 1-7, wherein the first calcination temperature is from 850° C. to 950° C.

Embodiment 9 is the process of any one of embodiments 1-8, wherein milling includes a grinding media combined with the composite powder.

Embodiment 10 is the process of any one of embodiments 1-9, wherein the grinding media comprises at least one material from the group of silicon carbide, tungsten carbide, alumina, zirconia, or combinations thereof.

Embodiment 11 is the process of any one of embodiments 1-10, wherein the milled powder has an average mean particle size of less than 5 microns.

Embodiment 12 is the process of any one of embodiments 1-11, wherein the heavy liquid has a density that is greater than 2.44 g/cm³ at 20° C.

Embodiment 13 is the process of any one of embodiments 1-12, wherein the heavy liquid comprises bromoform, dibromomethane, tetrabromomethane, diiodomethane, or combinations thereof.

Embodiment 14 is the process of any one of embodiments 1-13, further comprising: calcining the milled powder at a second calcination temperature to yield a calcined powder; and milling the calcined powder.

Embodiment 15 is the process of any one of embodiments 1-14, wherein the second calcination temperature is greater than the first calcination temperature.

Embodiment 16 is the process of any one of embodiments 1-15, wherein the second calcination temperature is at least equal to or greater than 1000° C., preferably from 1000° C. to 1200° C.

Embodiment 17 is the process of any one of embodiments 1-16, wherein the calcining step, either at the first or second calcination temperature, is done in an inert atmosphere or under vacuum.

Embodiment 18 is the process of any one of embodiments 1-17, wherein the milled powder is loaded into a crucible that is at least partially surrounded by a sacrificial layer.

Embodiment 19 is the process of embodiment 20, wherein the sacrificial layer comprises beryllium, beryllium carbide, carbon, molybdenum and combinations thereof.

Embodiment 20 is the process of any one of embodiments 1-19, wherein the at least a portion is separated from the suspension by filtration and/or centrifuge.

Embodiment 21 is the process of any one of embodiments 1-20, wherein the at least a portion is dried for at least 5 minutes.

Embodiment 22 is the process of any one of embodiments 1-21, wherein the beryllium carbide powder comprises less than 1.5% by weight of beryllium oxide.

Embodiment 23 is the process of any one of embodiments 1-22, wherein the beryllium carbide powder comprises less than 0.5% by weight of beryllium oxide.

Embodiment 24 is a process for producing beryllium carbide powder comprising calcining a composition comprising a beryllium-containing compound and a carbon powder at a first calcination temperature to yield a composite powder; milling the composite powder to form a milled powder; calcining the milled powder at a second calcination temperature to yield a calcined powder; milling the calcined powder to form a calcined milled powder; stirring the calcined milled powder in a heavy liquid to form a suspension; and separating at least a portion from the suspension to yield the beryllium carbide powder.

Embodiment 25 is the process of embodiment 24, wherein a molar ratio of beryllium in the beryllium-containing compound to the carbon powder is from 3:1 to 1.1:1.

Embodiment 26 is the process of any one of embodiments 24 or 25, wherein the beryllium-containing compound comprises at least one from the group of beryllium, beryllium hydride, beryllium chloride, beryllium fluoride, or combinations thereof.

Embodiment 27 is the process of any one of embodiments 24-26, wherein the beryllium-containing compound is a beryllium powder.

Embodiment 28 is the process of embodiment 27, wherein the beryllium powder has an average mean particle size of less than or equal to 50 microns.

Embodiment 29 is the process of any one of embodiments 24-28, wherein the carbon powder has an average mean particle size of less than 50 microns.

Embodiment 30 is the process of any one of embodiments 24-29, wherein the composition is loaded into a crucible that is at least partially surrounded by a sacrificial layer.

Embodiment 31 is the process of embodiment 32, wherein the sacrificial layer comprises beryllium, beryllium carbide, carbon, molybdenum and combinations thereof.

Embodiment 32 is the process of any one of embodiments 24-31, wherein the first calcination temperature is at least equal to or greater than 850° C.

Embodiment 33 is the process of any one of embodiments 24-32, wherein the first calcination temperature is from 850° C. to 950° C.

Embodiment 34 is the process of any one of embodiments 24-33, wherein the milled is loaded into a crucible that is at least partially surrounded by a sacrificial layer prior to calcining the milled powder at the second calcination temperature.

Embodiment 35 is the process of any one of embodiments 24-34, wherein the sacrificial layer comprises beryllium, beryllium carbide, carbon, molybdenum and combinations thereof.

Embodiment 36 is the process of any one of embodiments 24-35, wherein the second calcination temperature is greater than the first calcination temperature.

Embodiment 37 is the process of any one of embodiments 24-36, wherein the second calcination temperature is at least equal to or greater than 1000° C., preferably from 1000° C. to 1200° C.

Embodiment 38 is the process of any one of embodiments 24-37, wherein the calcining step, either at the first or second calcination temperature, is done in an inert atmosphere or under vacuum.

Embodiment 39 is the process of any one of embodiments 24-38, wherein milling includes a grinding media combined with the composite powder.

Embodiment 40 is the process of embodiment 39, wherein the grinding media comprises at least one material from the group of silicon carbide, tungsten carbide, alumina, zirconia, or combinations thereof.

Embodiment 41 is the process of any one of embodiments 24-40, wherein the milled powder has an average mean particle size of less than 5 microns.

Embodiment 42 is the process of any one of embodiments 24-41, wherein the heavy liquid has a density that is greater than 2.44 g/cm³ at 20° C.

Embodiment 43 is the process of any one of embodiments 24-42, wherein the heavy liquid comprises bromoform, dibromomethane, tetrabromomethane, diiodomethane, or combinations thereof.

Embodiment 44 is the process of any one of embodiments 24-43, wherein the at least a portion is separated from the suspension by filtration and/or centrifuge.

Embodiment 45 is the process of any one of embodiments 24-44, wherein the at least a portion is dried for at least 5 minutes or more.

Embodiment 46 is the process of any one of embodiments 24-45, wherein the beryllium carbide powder comprises less than 1.5% by weight of beryllium oxide.

Embodiment 47 is the process of any one of embodiments 24-46, wherein the beryllium carbide powder comprises less than 0.5% by weight of beryllium oxide.

Embodiment 48 is a process for producing beryllium carbide powder comprising: calcining a composite powder comprising beryllium carbide at a calcination temperature of less than 1200° C., wherein the composite powder is in a crucible that is at least partially surrounded by a sacrificial layer; milling the composite powder to form a milled powder; stirring the milled powder in a heavy liquid to form a suspension; and separating at least a portion from the suspension to yield the beryllium carbide powder.

Embodiment 49 is the process of embodiment 48, wherein the sacrificial layer comprises beryllium, beryllium carbide, carbon, molybdenum and combinations thereof.

### EXAMPLES

### Examples 1-3

The conditions for first calcination were tested under three examples to compare formation of beryllium carbide and amount of beryllium oxide. Beryllium and carbon precursors were calcined in a graphite crucible at a calcination temperature and time period as indicated in Table 1. Table 1 also reported the quantitative analysis by XRD to determine the content of each phase in weight percent.

TABLE 1

| | Example 1 | Example 2 | Example 3 |
|---|---|---|---|
| Calcination | 900° C. to | 930° C. to | 930° C. to |
| temperature | 930° C. | 1050° C. | 1000° C. |
| Calcination | 8 hours | 32 hours | 16 hours |
| time period | | | twice |
| Phase | Content (wt. %) | | |
| Be₂C | 84.7 | 91.7 | 88.2 |
| Be | 6.3 | 0.4 | 5.7 |
| BeO | 2.4 | 2.5 | 2.2 |
| C | 6.6 | 5.5 | 3.9 |
| Be₂C/BeO | 35.3 | 36.7 | 40.1 |
| Wt Ratio | | | |

Comparison of Example 1 and Example 2 shows the higher temperature of 1050° C. combined with 24 additional hours of calcination has produced a higher concentration of Be₂C. The high calcination temperature does not just increase the formation of Be₂C, but it also depletes Be.

The amount of BeO in Table 1 was similar throughout all three specimens. To configure the calcination approach for the formation of Be₂C from three calcinations in Table 1, the weight ratio of Be₂C to BeO was calculated. When the weight ratio of Example 2 is compared with that from Example 3, Example 2 produced more Be₂C. This is due to the relatively high maximum calcination temperature (1050° C. vs 1000° C.). However, the ratio of Be₂C formation to BeO shows that Example 3, which two times of calcinations, is more the effective approach to form Be₂C. Table 1 also shows Examples 3 results in less loss of Be.

After the calcination, no subsequent calcination, milling or heavy liquid was used in Examples 1-3.

### Examples 4-7

The conditions for second calcination were tested under four examples to compare formation of beryllium carbide and amount of beryllium oxide used Example 1 as the first calcination conditions, i.e. from 900° C. to 930° C. for 8 hours. The milled calcinated material from Example 1 was calcined in a graphite crucible at a second calcination temperature as indicated in Table 2 for a time period of 8 hours. Table 2 also reported the quantitative analysis by XRD to determine the content of each phase in weight percent. Example 7 used a sacrificial layer.

TABLE 2

| | Example 1 | Example 4 | Example 5 | Example 6 | Example 7 |
|---|---|---|---|---|---|
| 2^{nd} | — | 1050° C. | 1150° C. | 1250° C. | 1050° C. |
| Calcination | | | | | |
| Temperature | | | | | |
| Phase | Content (wt. %) | | | | |
| Be₂C | 84.7 | 90.9 | 88.8 | 89.2 | 94.1 |
| Be | 6.3 | — | — | — | — |
| BeO | 2.4 | 8.3 | 8.9 | 10.0 | 5.9 |
| C | 6.6 | 0.8 | 2.3 | 0.7 | — |
| Be₂C/BeO | 35.3 | 11.0 | 10.0 | 8.9 | 15.9 |
| Wt Ratio | | | | | |

The milling process after the first calcination resulted in mixing of un-reacted beryllium and carbon during the first calcination and promoted the formation of more Be₂C during the second calcination. There is no remaining beryllium after the second calcination, as seen in Table 2. By increasing the temperature of the re-calcination from 1050° C. to 1250° C., the amount of Be₂C was unchanged but the amount of BeO was increased slightly. The ratio of Be₂C formation to BeO from Example 4-7 is shown in Table 2. The efficacy of Be₂C formation with a 1050° C. re-calcination temperature (Example 4) is demonstrated an improvement without the sacrificial layer.

Example 7 which used the sacrificial Be₂C powder during calcination showed that the amount of Be₂C was increased to 94.1 wt. % and the formation of BeO was reduced to 5.9 wt. %. Comparing the content of the calcined powder of Example 7 with that of Example 4, the amount of Be₂C was increased 3.2 wt. % (from 90.9 wt. % to 94.1 wt. %) and the formation of BeO was decreased 2.4 wt. %. less (from 8.3 wt. % to 5.9 wt. %).

After the second calcination, no subsequent calcination, milling or heavy liquid was used in Examples 4-7.

### Example 8

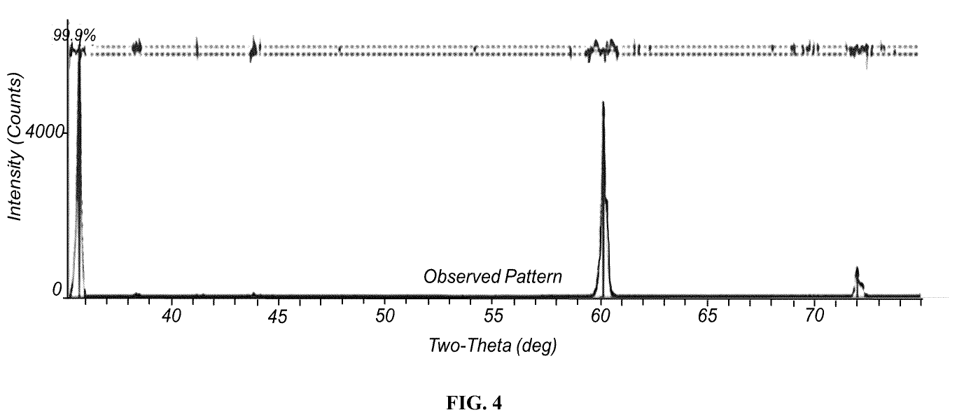

Beryllium carbide was prepared according the process described herein using two calcination steps. Beryllium and carbon precursors were calcined in a graphite crucible at a first calcination temperature of 900° C. to 930° C. and held for 8 hours under vacuum. After (the first) calcining, milling was performed in a polymer lined milling jar with silicon carbide as the grinding media. The milled powder was returned to the crucible and surrounded with a sacrificial Be₂C powder. The powder was then calcined at a second calcination temperature of 1050° C. for 8 hours followed by milling. Milling used either SiC grinding media or tungsten carbide grinding media. The heavy liquid dibromomethane was stirred into the milled powder to segregate the non-Be₂C powders. The suspended Be₂C was collected by a filtering or centrifuging and then dried in a drying oven. FIG. 4 is an x-ray diffraction (XRD) pattern of the Be₂C powder showing a purity of greater than 99.9% by weight and a very low beryllium oxide of less than 0.1% by weight.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

1. A process for producing beryllium carbide powder comprising:
calcining a composition comprising a beryllium-containing compound and a carbon powder at a first calcination temperature to yield a composite powder;
milling the composite powder to form a milled powder;
stirring the milled powder in a heavy liquid to form a suspension; and
separating at least a portion from the suspension to yield the beryllium carbide powder.

2. The process of claim 1, wherein a molar ratio of beryllium in the beryllium-containing compound to the carbon powder is from 3:1 to 1.1:1.

3. The process of claim 1, wherein the beryllium-containing compound comprises at least one from the group of beryllium, beryllium hydride, beryllium chloride, beryllium fluoride, or combinations thereof.

4. The process of claim 1, wherein the beryllium-containing compound is a beryllium powder and wherein the beryllium powder has an average mean particle size of less than or equal to 50 microns.

5. The process of claim 1, wherein the carbon powder has an average mean particle size of less than 50 microns.

6. The process of claim 1, wherein the first calcination temperature is at least equal to or greater than 850° C.

7. The process of claim 1, wherein milling includes a grinding media combined with the composite powder and wherein the grinding media comprises at least one material from the group of silicon carbide, tungsten carbide, alumina, zirconia, or combinations thereof.

8. The process of claim 1, wherein the heavy liquid has a density that is greater than 2.44 g/cm³ at 20° C.

9. The process of claim 1, wherein the heavy liquid comprises bromoform, dibromomethane, tetrabromomethane, diiodomethane, or combinations thereof.

10. The process of claim 1, further comprising:
calcining the milled powder at a second calcination temperature to yield a calcined powder; and
milling the calcined powder.

11. The process of claim 10, wherein the second calcination temperature is at least equal to or greater than 1000° C., preferably from 1000° C. to 1200° C.

12. The process of claim 10, wherein the calcining step, either at the first or second calcination temperature, is done in an inert atmosphere or under vacuum.

13. The process of claim 10, wherein the milled powder is loaded into a crucible that is at least partially surrounded by a sacrificial layer.

14. The process of claim 13, wherein the sacrificial layer comprises beryllium, beryllium carbide, carbon, molybdenum and combinations thereof.

15. The process of claim 1, wherein the beryllium carbide powder comprises less than 1.5% by weight of beryllium oxide, preferably less than 0.5% by weight of beryllium oxide.
